(19) United States
(12) Patent Application Publication
(10) Pub. No.: US 2006/0029110 A1
(43) Pub. Date: Feb. 9, 2006

(54) Cavity monitoring device for pulse laser

(75) Inventors: Gyu Choen Cho, Ann Arbor, MI (US); Hideyuki Ohtake, Aichi (JP); Michiharu Ohta, Aichi (JP)

Correspondence Address: SUGHRUE MION, PLLC, 2100 PENNSYLVANIA AVENUE, N.W., SUITE 800, WASHINGTON, DC, 20037, US

(73) Assignee: IMRA AMERICA, INC.

(21) Appl. No.: 10/909,377

(22) Filed: Aug. 3, 2004

(51) Int. Cl. H01S 3/30

(52) U.S. Cl. 372/6

(57) ABSTRACT

A fiber laser system is provided with a laser cavity including at least a gain fiber, an output coupling mirror, and a saturable absorber mirror. A photo sensor detects leakage light passing through the saturable absorber mirror, for purposes of monitoring the performance of the laser system. The saturable absorber mirror may include a semiconductor saturable absorber having a Bragg reflector monolithically formed on one side thereof.

### FIELD OF THE INVENTION

The present invention relates to a monitor for detecting performance prameters of a pulsed laser. In particular the invention is for a fiber laser cavity with a saturable absorber modulator.

### BACKGROUND OF THE INVENTION

A compactly packaged laser cavity with a minimum number of components has a number of advantages. It stimulates a broader application market where the small form factor of the laser is a considerable advantage; for example for integration into a portable instrument. Also the small form factor reduces mechanical instability, allowing operation over a wide range of mechanical perturbation than a solid-state laser can allow. Moreover, the composite failure rate of the system drops, which in turn enhances the yield and productivity of manufacturing of such laser systems.

One challenging task in the arena of laser technology is to bring ultrashort lasers within the realm of industrial manufacturing. One advantage of fiber lasers is their robustness against environmental perturbation with telecom-grade fiber optical components, which are suitable for industrial manufacturing. A passively mode-locked fiber laser is the most suitable concept for the mission.

Basically a passively mode-locked fiber laser needs the following minimum basic components: a fiber doped with a proper optically active dopant, a passive modulator, a dispersion managing device, an out-coupling device for cavity light, an optical pumping device and a device coupling the pump light into the gain fiber.

In practice, however, additional components are usually required. A Faraday rotator, a polarizer, a wave plate and an isolator between the gain fiber and pump laser are typical additional components, for example, as detailed in U.S. Pat. No. 5,689,519. In addition, focusing and collimating optics for the modulator and for the out-coupling mirror, respectively, are inevitable.

For the gain medium, the most widely used active dopants are Er, Er/Yb or Yb, depending on the wavelength. In a soliton laser the fiber itself serves as the dispersion managing device with proper length selection. For femtosecond pulse generation, typically a saturable absorber mirror is used as a cavity mirror at one end of the gain fiber, with focusing and collimation lenses. At the other end of fiber an out-coupling mirror in combination with a collimating lens is placed to extract light out of the cavity. The pumping device is usually a semiconductor laser diode with a fiber pig tail. The pump light is coupled into the gain fiber with a wavelength domain multiplexer. In order to protect the pump device against high intensity mode-locked pulses from the cavity, an optical isolator needs to be placed between the coupler and the pump device. For the modulator, a semiconductor saturable absorber (see, U.S. Pat. No. 4,860,296) has been proven to be the most reliable device in the past decade. Numerous oscillator designs employing semiconductor saturable absorbers have been published. (see, U.S. Pat. No. 5,007,059, U.S. Pat. No. 6,252,892, U.S. Pat. No. 6,538,298, and U.S. Ser. No. 10/627069) The environmental robustness of the operating condition has been shown to be significantly improved by the combination of saturable absorber and fiber optics. (see, U.S. Ser. No. 10/627069)

In a recently disclosed invention it has been demonstrated that the number of components can be significantly reduced. (see, U.S. Ser. No. 10/627069) In this disclosure, a chirped fiber Bragg grating has been used for both dispersion management and the out-coupling mirror. No additional coupling optics are required. In the same disclosure it has been shown that a pump combiner with a multiple stack of dichroic mirrors in a wavelength division multiplexer provide sufficient optical isolation of the pump device, making the use of a discrete optical isolator obsolete. The use of polarization maintaining fiber makes the polarizer and wave plate unnecessary. In another disclosure (see, U.S. Pat. No. 5,666,373), it has also been proposed to extract the laser pulse through a saturable absorber mirror as an output coupler, while placing a high reflection mirror at the other end of the fiber.

A saturable absorber imbedded in a biased vertical-cavity-surface-emitting laser structure can be used for monitoring photo current generated by the cavity pulses as proposed in U.S. Pat. No. 6,252,892 and prior art referenced therein. However, this approach requires the unnecessary complexity of fabricating an electrically active semiconductor device. Such a design requires bias layers where electronic junction properties are the key, which is not required for the functionality of a saturable absorber. Furthermore, the size constraint, below 1 mm², in order to resolve a pulse train ranging from tens of megahertz to hundreds of megahertz, makes the assembly of the absorber in a cavity difficult.

The prior art also discloses a method detecting the pulse repetition rate generated by an ultrashort fiber laser. U.S. Pat. No. 5,778,016 describes registering photo diode current measuring the light out-coupled out of a bidirectional polarizing beam splitter, used also as an output coupler. This method is only feasible if the cavity is designed with additional components such as wave plates and a polarizing beam splitter as proposed in earlier art (see, U.S. Pat. No. 5,689,519). A widely practiced method for fiber lasers, involves adding a fiber coupler outside of the cavity. The fiber coupler is a device splitting a fraction of the light from the main route of light travel in or in/out of the fiber. The coupler is usually packaged with a fiber pigtail, so that the device is fusion-spliced together with other system fiber. Here, not only is the additional component a drawback, but also the extra fiber pigtail length is a disadvantage. Any additional fiber dispersion can cause difficulties in delivering ultrashort pulses of a few hundreds of femtoseconds. Perfect compensation of fiber dispersion for a broad (>10 nm) spectral femtosecond pulse is well known to be challenging in the laser community. U.S. Pat. No. 6,570,892 indicates, however, the practice of using this type of additional and external coupler in order to detect the pulse train.

Increasing the functionality integrated into each component is likely the key concept for meeting the requirements for a manufacturable ultrashort laser. The advantage of this approach, leading to a reduction of the number of components, becomes more significant if a laser is implemented into an application system. Due to the complexity of such system, the cavity performance needs to be monitored during operation in order to prevent malfunction, which can result in costly damage of the system and the application. The seeder of the laser for an amplifier is an example. A failure of mode-locking can cause catastrophic damage to the amplifier.

### BRIEF DESCRIPTION OF THE DRAWINGS

FIG. 1 is a diagram showing an exemplary structure of the saturable absorber. A reflective layer (102) beneath the absorbing layer (101) serves a cavity mirror where leakage light travels through the mirror structure. A dielectric coating (103) is deposited on the absorbing layer.

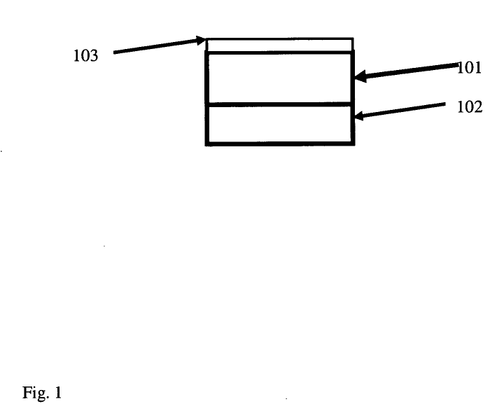

FIG. 2 is a block diagram of the saturable absorber integrated with a photo sensor in a package (209). The light out of the gain fiber (201) through an angle polished fiber ferrule (202) is collimated with a collimating lens (203). After an optional polarizing element (204) the light focuses onto saturable absorber (206) with a focusing lens (205). The saturable absorber (206) is mounted on a mount (207). Light passing through the saturable absorber is incident on a photo sensor (208).

FIG. 3 is a diagram showing an exemplary implementation of the package for saturable absorber (206) and a photo sensor (208). The saturable absorber is mounted directly onto a transparent window (301) of a semiconductor photo diode package of the “can” type (302). Numeral 303 represents the electrodes of the photo diode.

FIG. 4 is a diagram of an exemplary implementation of a saturable absorber with integrated monitor into the fiber laser system. The fiber laser system includes a gain fiber (201), fiber ferrule (202), fiber Bragg grating (401) for an output coupler, pump coupler (402), pump laser (403) and saturable absorber package (209) with an integrated photo diode (302) having electrodes (303). An electronic amplifier (404) amplifies the signal in form of photo current and the frequency of the pulse train in the amplified signal is measured by a frequency counter (405).

FIG. 5 is a diagram showing the pulse train detected with the photo diode. The graph was recorded with an oscilloscope connected to the photo diode via a preamplifier. The data shows the repetition rate of the pulse train and the amplitude (light intensity) of the pulse.

### SUMMARY OF THE INVENTION

A saturable absorber fabricated of semiconductor is used for passive mode-locking of an Er-doped fiber laser. The absorber layer is combined with a reflective device, such as dielectric mirror, metal mirror or semiconductor Bragg reflector in order to provide the functionality of a cavity mirror positioned at one end of the gain fiber. The transmittance of the mirror device is adjusted in order to leak light out of the cavity. The leakage light is used exclusively for monitoring laser performance. The extraction of the cavity light for the laser application is realized by another cavity mirror, positioned at the other end of the gain fiber. A partially reflective mirror structure or a fiber Bragg grating is used for the output coupler. The objectives for monitoring are the repetition rate of the laser pulse, power level and the verification of the mode-locking or Q-switching operation. The invention also discloses a method for integration of a photo sensor with the saturable absorber modulator into one package.

### DESCRIPTION OF THE PREFERRED EMBODIMENT

The preferred laser is a linear fiber cavity pumped by one or more laser diodes. It comprises a gain fiber with an Er and/or Yb dopant, an output coupling device comprising either a partial reflectance mirror or fiber Bragg grating, and a saturable absorber modulator with a reflective device. The extraction of the laser pulse out of the cavity is realized by the output coupling mirror. The transmittance of such an output mirror is typically larger than 10%. The high gain in the fiber requires a relatively high transmission rate compared to a solid state laser, where a rate of few percent is common. The preferred saturable absorber is fabricated out of InP-related semiconductor. For Er doped fiber, a bulk layer of InGaAsP grown on an InP substrate is preferred. However, a quantum well absorber is another preference. A reflective device (102) is attached beneath the absorber layer (101). A dielectric coating (103), usually an anti-reflection coating, is deposited on the absorber layer.

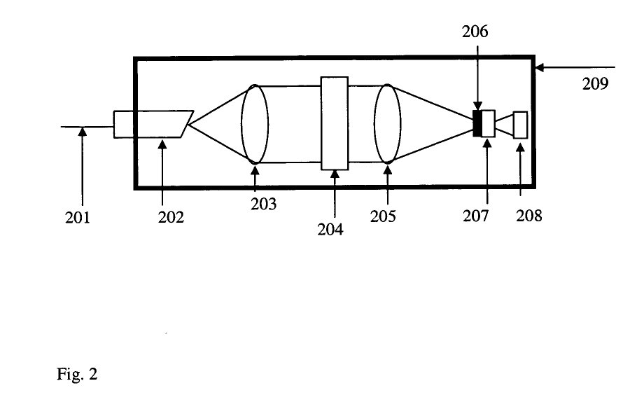

The schematic of the saturable absorber package in FIG. 2 depicts the light path. This package is mounted at one end of the gain fiber and has the functionality of a modulator. The light out of the gain fiber (201) goes through an angled ferrule (202), which is subsequently collimated with a collimation lens (203) and refocused on the saturable absorber (206) with a focusing lens (205). An optional polarizer (204) can be used in the collimated light path in order to support the polarization maintenance of the light. Leakage light through the saturable absorber and reflector device on the order of 10⁻³ with respect to the incident optical power onto the saturable absorber illuminates the photo sensor (208). Due to the ability to monolithically grow a semiconductor Bragg reflector on the same wafer as the absorber, where two semiconductor layers with different indices of refraction are grown periodically, this is preferred for the reflective device. A dielectric mirror deposited on the absorber is another preference for the reflector.

A heat sink (not shown) may be provided on said saturable absorber, nominally in the path of the leakage light. In such a case, the heat sink would be apertured for leaked light travel therethrough to the photo sensor.

For the photo sensor a sensitive photo diode is preferred. A sensitivity >0.9 A/W can be easily achievable and leakage light of few micro watts is sufficient for the monitoring purpose. Considering the typical intracavity power of a fiber laser of tens of milliwatts, this requires a transmittance of less than of 10⁻³ through the absorber and mirror device. This amount of transmittance can be easily realized for a semiconductor Bragg reflector or a dielectric coating. The layer thickness and material composition of the Bragg reflector layer or dielectric coating layer are extremely difficult to control to perfection. However, a coating design with accuracy of optical transmission or reflection better than 10⁻³ is not easily achievable at the industry level. That is, there is always a leakage of light on this order through the reflector device in most industrial grade coatings or grown layers, and therefore this design parameter is easily met.

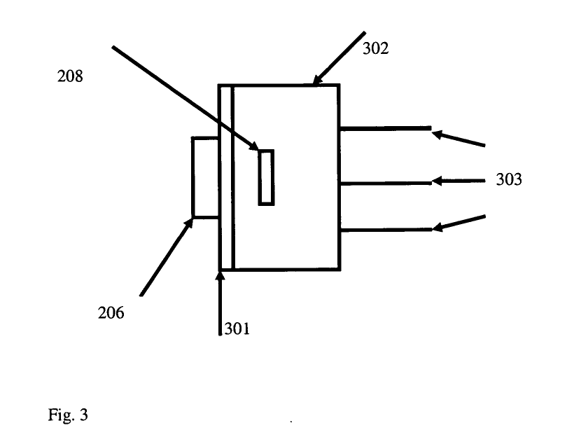

As shown in FIG. 3 the saturable absorber with a Bragg reflector formed on the wafer substrate can be mounted directly onto the photo diode package. InP wafer substrate is transparent for 1.55 um (the emission line of an Er doped fiber). Since the light in the cavity is focused onto the absorber in order to obtain proper absorption saturation, the beam size directly exiting the mirror device is well below 0.5 mm. No additional focusing lens is necessary for the photo sensor. An InGaAs photo diode (Model G8376-03) in a metal TO-18 package (302) from Hamamatsu Photonics is used. This package has a transparent optical window (301) and the absorber (206) is attached directly onto the window using a transparent glue. Since the optical power is extremely low, photo damage to the glue is not an issue. Such an optically transparent epoxy can be obtained, for example, from Norland. This configuration makes the package extremely simple and cost effective.

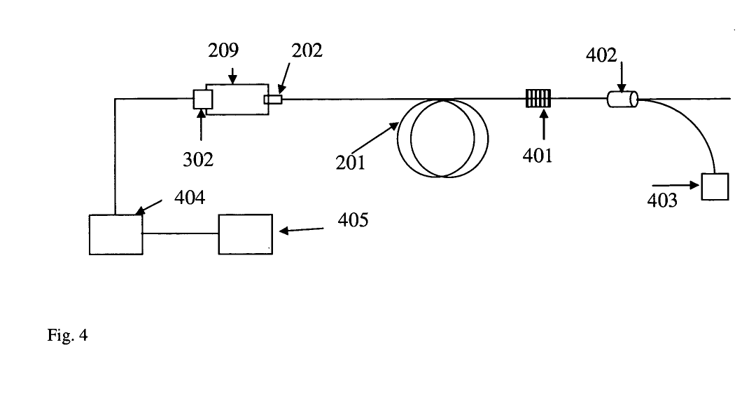

FIG. 4 shows an exemplary implementation of the invention in a fiber laser system. The gain fiber (201) is either Yb or Er doped fiber. The gain fiber is pumped by a 980 nm pump diode (403) with a pump coupler (402). For the output coupling of light out of the cavity a fiber Bragg grating (401) is used. The saturable absorber chip in the saturable absorber package (209) is mounted onto a TO-can window of a Hamamatsu photo diode (302). The photo diode can be biased through the electrodes (303). The electrodes (303) also deliver the photo current generated by the laser pulses to monitor electronics. The photo current is converted into voltage and amplified by an electronic amplifier (404). The amplified photo current signal carrying the information of the pulse train is fed into a frequency counter (405).

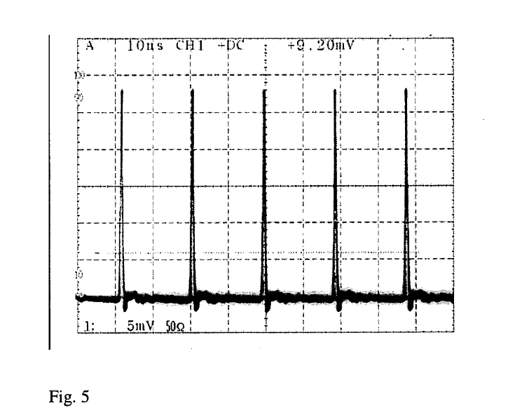

FIG. 5 shows the pulse train measured with the photo diode packaged as in FIG. 3. The photo diode detects two parameters of the laser. The first one is the pulse intensity. One use of the monitored pulse intensity is to keep the laser output at a constant level with a proper feedback loop by adjusting the pump diode current. This application also provides a stable mode-locking operation upon environmental perturbation such as temperature and mechanical vibration. In this way, the change in the gain dynamics over temperature can be compensated keeping a steady-state mode-locking condition of the cavity. The second detected output parameter is the repetition rate of the mode-locked pulse train. The detection of well defined frequency is a clear indication of the mode-locking operation of the laser. If the laser is in cw operation or in mode-locked Q-switching mode, where mode-locking concomitantly exists in the presence of Q-switching, either no pulse frequency is detected or the frequency detected is not well defined and unstable. Furthermore the detected frequency can be used as a clock. For an amplifier system the clock provides the reference frequency of the optical modulator used to reduce the pulse repetition rate for high pulse energy amplification.

What is claimed is:

1. A fiber laser system, comprising;
a laser cavity including at least a gain fiber, an output coupling mirror, and a saturable absorber mirror; and a photo sensor detecting leakage light passing through the saturable absorber mirror; wherein said photo sensor and said leakage light are used exclusively for monitoring the performance of the laser system.

2. A system as claimed in claim 1, wherein said saturable absorber mirror is an integral unit comprising a semiconductor saturable absorber having a Bragg reflector monolithically formed on one side thereof.

3. A system as claimed in claim 1, wherein said saturable absorber mirror comprises a semiconductor saturable absorber having a dielectric or partial metallic reflector on one side thereof.

4. A system as claimed in claim 1, wherein said photo sensor includes a window at a light-input end thereof, said window being fixed directly to a reverse side of said saturable absorber mirror.

5. A system as claimed in claim 1, further including monitor electronics connected to said photo sensor for monitoring at least one of an intracavity power level, a cw mode-locking mode and a Q-switching mode, by detecting at least one of a light intensity level, an intracavity pulse repetition rate, and a pulse modulation period.

6. A system as claimed in claim 1, wherein a focusing device is located between the saturable absorber mirror and the photo sensor.

7. A system as claimed in claim 1, wherein a heat sink is provided on said saturable absorber and is apertured for leaked light travel therethrough to the photo sensor.

8. A system as claimed in claim 1, wherein the saturable absorber and photo sensor form a single unitary package.

9. An optical modulator apparatus, comprising;
a modulator unit including at least an integrally formed saturable absorber and mirror; and a photo sensor optically coupled to said modulator for detecting light passed through the saturable absorber and mirror.

10. An optical modulator apparatus, comprising;
a modulator unit including at least an integrally formed saturable absorber and mirror; and a photo sensor optically coupled to said modulator for detecting light passed through the saturable absorber and mirror, said light being diminished in intensity by approximately three orders of magnitude in passing through said saturable absorber and mirror.

11. A cavity end-unit for a laser system, comprising;
a modulator unit including at least a saturable absorber and an end mirror; and a photo sensor optically coupled to said modulator for detecting light passing through the saturable absorber and mirror.

12. A diagnostic apparatus for a laser system, comprising;
a modulator unit including at least a saturable absorber and a mirror, and a light detecting unit optically coupled to said modulator for detecting leakage light passing through the saturable absorber and mirror.

13. An apparatus as claimed in claim 12, wherein said modulator unit comprises one cavity end of said laser.
